(19) United States
(12) Patent Application Publication
(10) Pub. No.: US 2011/0189464 A1
(43) Pub. Date: Aug. 4, 2011

(54) MELAMINE-FORMALDEHYDE FOAM WITH BUILT-IN MICROCAPSULES

(75) Inventors: Tobias Heinz Steinke, Speyer (DE); Marc Rudolf Jung, Worms (DE); Andreas Daiss, Deidesheim (DE); Hans-Jürgen Quadbeck-Seeger, Bad Durkheim (DE); Klaus Hahn, Kirchheim (DE); Horst Baumgartl, Ludwigshafen (DE); Jens-Uwe Schierholz, Bensheim (DE); Bettina Wester, Mannheim (DE); Christof Möck, Mannheim (DE)

(73) Assignee: BASF SE, Ludwigshafen (DE)

(21) Appl. No.: 13/016,420

(22) Filed: Jan. 28, 2011

Related U.S. Application Data
(60) Provisional application No. 61/300,841, filed on Feb. 3, 2010.

(51) Int. Cl. B32B 3/26; B32B 5/16; C08G 12/32; C08J 9/35

(52) U.S. Cl. 428/304.4; 521/187; 521/50.5

(57) ABSTRACT

Novel melamine-formaldehyde foams comprising microcapsules built into the structure of the condensation products and also processes for the production thereof and uses thereof.

The present invention relates to melamine-formaldehyde foams comprising microcapsules built into the structure of said foam.

EP-A-17 672 and EP-37 470 disclose elastic foams based on melamine-formaldehyde condensation products and also a process for their production.

WO-A-2008/37600 discloses that the inherently hydrophilic melamine resin foams can be converted into hydrophobic melamine resin foams by impregnation with water-rejecting chemicals such as fluorocarbon resins for example.

WO-A-2006/8054 discloses modified open-cell foams having a density in the range from 5 to 1000 kg/m³ and an average pore diameter in the range from 1 μm to 1 mm, comprising from 1% to 2500% by weight, based on the weight of the unmodified open-cell foam, of at least one chain growth addition polymer which is solid at room temperature, comprises carboxyl and/or carboxylic ester groups and has a molecular weight Mₙ in the range from 1000 to 1 000 000 g/mol.

However, this subsequent treatment leaves something to be desired since it is associated with additional operations such as impregnation, pressing and drying.

It is an object of the present invention to remedy the aforementioned disadvantages.

We have found that this object is achieved by novel melamine-formaldehyde foams comprising microcapsules built into the structure of said foams as well as processes for the production thereof and uses thereof.

The present-invention melamine-formaldehyde foams comprising microcapsules built into the structure of said foams comprise an open-cell scaffolding of foamed material, the scaffolding comprising a multiplicity of interconnected, three-dimensionally branched struts, and in each of which the microcapsules are embedded into the foam structure, preferably at the nodal points (foam regions at which two or more struts meet). The microcapsules are thus firmly bonded to the melamine resin of which the foamed material consists.

Depending on capsule size, the microcapsules can be incorporated specifically at the nodal points or to form a dispersion throughout the entire foam structure. When the capsule radius is less than the strut diameter of the foam structure, the capsules are able to disperse in the entire strutted structure. When the capsule radius is chosen to be larger than the strut diameter, then the capsules preferentially collect at the nodal points of the foam structure.

The proportion of microcapsules in the melamine resin foam is in the range from 0.01% to 50% by weight, preferably 1-15% by weight.

The present-invention melamine-formaldehyde foams comprising microcapsules built into the structure of the condensation products can be produced as follows:

The microcapsules can be added to the melamine, to the formaldehyde, to their mixtures or to a melamine-formaldehyde precondensate in the course of the foaming operation, preferably prior to the foaming operation of one or more of the components, melamine, formaldehyde, their mixtures or a melamine-formaldehyde precondensate.

In general, what can be incorporated and mixed, at temperatures of 0 to 200° C., and a pressure of 0.01 to 50 bar, with the microcapsules, optionally spray dried or in the form of dispersions, is a melamine-formaldehyde precondensate, optionally spray dried, or the individual components or a mixture of melamine and formaldehyde and the blowing agent and optionally in a solvent and optionally one or more dispersants/emulsifiers and/or additional components. The resulting mixture can be stirred to the point of a homogeneous mixture/suspension/emulsion, respectively. Mixing the components can be effected using any process known to a person skilled in the art, for example in a static mixer.

The next step of the process of the present invention comprises the precondensate being foamed up generally by heating the solution or dispersion of the melamine-formaldehyde precondensate to obtain a foamed material comprising microcapsules. To this end, the solution or dispersion is generally heated to a temperature above the boiling point of the blowing agent used and foamed in a closed mold.

The introduction of energy may preferably be effected via electromagnetic radiation, for example via high-frequency radiation at 5 to 400 kW, preferably 5 to 200 kW and more preferably 9 to 120 kW per kilogram of the mixture in a frequency range from 0.2 to 100 GHz, preferably 0.5 to 10 GHz. Magnetrons are a useful source of dielectric radiation, and one magnetron can be used or two or more magnetrons at the same time.

The foamed materials produced are finally dried, removing residual water and blowing agent from the foam.

The processes of the present invention leave the microcapsules intact to a substantial degree, i.e., to a degree in the range from 70% to 100%, preferably from 85% to 100%, more preferably from 95% to 100%, and more particularly from 98% to 100%, with their contents intact.

As melamine-formaldehyde precondensates there may be used especially prepared precondensates of the two components, melamine and formaldehyde (see reviews: a) W. Woebcken, Kunststoffhandbuch 10. Duroplaste, Munich, Vienna 1988, b) Encyclopedia of Polymer Science and Technology, 3rd ed., Vol.1, chapter Amino Resins, pages 340-370, 2003, c) Ullmann's Encyclopedia of Industrial Chemistry, 6th ed., Vol. 2, chapter Amino Resins, pages 537-565. Weinheim 2003) or commercially available precondensates of the two components, melamine and formaldehyde. Melamine-formaldehyde precondensates generally have a molar ratio of formaldehyde to melamine in the range from 5:1 to 1.3:1 and preferably in the range from 3.5:1 to 1.5:1.

These melamine-formaldehyde condensation products, in addition to melamine, may comprise from 0 to 50% by weight, preferably from 0 to 20% by weight, of other thermoset formers and, in addition to formaldehyde, 0 to 50% by weight, preferably 0 to 20% by weight, of other aldehydes, in cocondensed form. However, an unmodified melamine-formaldehyde condensation product is preferred.

Useful thermoset formers include for example alkyl- and aryl-substituted melamine, urea, urethanes, carboxamides, dicyandiamide, guanidine, sulfurylamide, sulfonamides, aliphatic amines, glycols, phenol and its derivatives.

Useful aldehydes include for example acetaldehyde, trimethylolacetaldehyde, acrolein, benzaldehyde, furfural, glyoxal, glutaraldehyde, phthalaldehyde and terephthalaldehyde. Further details concerning melamine-formaldehyde condensation products are found in Houben-Weyl, Methoden der organischen Chemie, Volume 14/2, 1963, pages 319 to 402.

Alcohols, for example methanol, ethanol or butanol, can be added in the course of the preparation of the melamine-formaldehyde precondensate in order to obtain partially or completely etherified condensates. The formation of ether groups can be used to influence the solubility of the melamine-formaldehyde precondensate and the mechanical properties of the completely cured material.

Microcapsules where the wall material is based on a highly crosslinked methacrylic ester polymer are known from EP-A-1 029 018, DE-A-101 39 171, WO-A-2005/116559 and prior European application EP application No. 06117092.4. They all concern microencapsulated phase change materials in different fields of application.

EP-A-1 029 018 teaches the use in bindered building materials such as concrete or gypsum, DE-A-101 39 171 teaches the use of microencapsulated phase change materials in plasterboard and WO-A-2005/116559 teaches their use in particle board. The microcapsules described in these references are all said to be very tight in both thermal and chemical treatment or under pressure.

DE-A-10 2007 055 813 describes the production and use of thermally destroyable microcapsules. The capsule wall is constructed of acrylates. The capsule core comprises lipophilic substances, such as aliphatic and aromatic hydrocarbyl compounds, saturated or unsaturated C₆-C₃₀ fatty acids, fatty alcohols, C₅-C₃₀ fatty amines, fatty acid esters, natural and synthetic waxes, halogenated hydrocarbons, silicone oils, adhesives, aroma chemicals, scents, active ingredients, dyes, color formers, pigments and crosslinkers.

The capsule wall of DE-A-10 2007 055 813 is constructed from polymers. The capsules have a size in the range from 0.5 to 100 μm, preferably in the range from 1 to 80 μm and more preferably in the range from 5 to 60 μm.

Useful microcapsules include such bodies as have a size in the range from 0.5 to 100 μm, preferably in the range from 1 to 80 μm and more preferably in the range from 5 to 60 μm, and have a capsule core and a capsule wall (see DE-A-10 2007 055 813 for example), the capsule wall generally being constructed of at least two mutually different monomers, 30% to 100% by weight of a monomer A from the group comprising C₁-C₂₄-alkyl esters of acrylic and/or methacrylic acid, acrylic acid, methacrylic acid and maleic acid, 0 to 30% by weight of one or more bi- or polyfunctional monomers B which are insoluble or sparingly soluble in water, and 0 to 40% by weight of one or more other monomers C, all based on the total weight of the monomers.

The microcapsules of the present invention generally comprise a capsule core and a capsule wall of polymer. The capsule core consists generally predominantly, to an extent from 70% to 100% by weight, preferably from 95% to 100% by weight and more preferably to an extent of 98% by weight, of lipophilic substance. The capsule core can be not only liquid but also solid, depending on the temperature.

Depending on the production process and the protective colloid used in that production process, that protective colloid can likewise be a constituent part of the microcapsules.

From 0 to 10% by weight, preferably 1% to 8% by weight and more preferably 1% to 6% by weight, based on the total weight of the microcapsules, can be protective colloid. In this embodiment, the microcapsules generally include the protective colloid on the surface of the polymer.

The average particle size of the capsules (Z-average by light scattering, Malvern, Fraunhofer diffraction) is in the range from 0.5 to 100 μm and preferably in the range from 1 to 80 μm. The weight ratio of capsule core to capsule wall, viz., the core/wall ratio, is generally in the range from 50:50 to 95:5, preferably in the range from 70:30 to 95:5 and more preferably in the range from 75:25 to 93:7.

The polymers of the capsule wall generally comprise from 30% to 100% by weight, preferably from 40% to 100% by weight, more preferably from 50% to 100% by weight, even more preferably from 60% to 100% by weight and yet even more preferably from 70% to 100% by weight of at least one monomer A from the group comprising C₁-C₂₄-alkyl esters of acrylic and/or methacrylic acid, acrylic acid, methacrylic acid and/or maleic acid in copolymerized form, based on the total weight of the monomers.

In addition, the polymers of the capsule wall may generally comprise from 0 to 30% by weight, preferably from 0 to 25% by weight and more preferably from 1% to 15% by weight of a bi- or polyfunctional monomer B which is insoluble or sparingly soluble in water, in copolymerized form.

In addition, the polymers of the capsule wall may comprise 0 to 40% by weight of other monomers C in copolymerized form.

The capsule wall is preferably constructed of monomers A and C, more particularly to a substantial degree, i.e., to a degree in the range from 95% to 100% by weight, preferably from 98% to 100% by weight and more preferably from 99% to 100% by weight, more particularly to an extent of 100% by weight of monomers A.

Useful monomers A include the C₁-C₂₄-alkyl esters of acrylic and/or methacrylic acid.

Useful monomers A further include the unsaturated C₃ and C₄ carboxylic acids such as acrylic acid, methacrylic acid and also maleic acid. By way of example there may be mentioned methyl acrylate, ethyl acrylate, n-propyl acrylate, isopropyl acrylate, n-butyl acrylate, isobutyl acrylate, sec-butyl acrylate, tert-butyl acrylate, methyl methacrylate, ethyl methacrylate, n-propyl methacrylate, isopropyl methacrylate, n-butyl methacrylate, isobutyl methacrylate, sec-butyl methacrylate and tert-butyl methacrylate. Useful monomers la, the homopolymers of which have a glass transition temperature (Tg) of ≦60° C., include for example the C₁-C₂₄-alkyl esters of acrylic acid and butyl methacrylate. There may be mentioned by way of example methyl acrylate, ethyl acrylate, propyl acrylate, n-butyl acrylate, t-butyl acrylate, n-pentyl acrylate, 2-methylbutyl acrylate, 3-methylbutyl acrylate, hexyl acrylate, ethylhexyl acrylate and propylheptyl acrylate. n-Butyl acrylate is preferred.

Useful monomers B include bi- or polyfunctional monomers which are insoluble or sparingly soluble in water but have good to limited solubility in the lipophilic substance.

Sparingly soluble is to be understood as meaning a solubility of less than 60 g/l, i.e., from 0 to 60 g/l, preferably from 0 to 50 g/l and more preferably from 0 to 30 g/l at 20° C. Bi- or polyfunctional monomers are compounds having at least two nonconjugated ethylenic double bonds. Divinyl and polyvinyl monomers are chiefly contemplated.

Useful divinyl monomers include divinylbenzene, trivinylbenzene and divinylcyclohexane and trivinylcyclohexane. Preferred divinyl monomers include the diesters of diols with acrylic or methacrylic acid and also the diallyl and divinyl ethers of these diols. Ethanediol diacrylate, ethylene glycol dimethacrylate, 1,3-butylene glycol dimethacrylate, methallylmethacrylamide, allyl acrylate and allyl methacrylate may be mentioned by way of example. Particular preference is given to propanediol diacrylate, butanediol diacrylate, pentanediol diacrylate and hexanediol diacrylate and the corresponding methacrylates.

Preferred polyvinylmonomers include the polyesters of polyols with acrylic acid and/or methacrylic acid and also the polyallyl and polyvinyl ethers of these polyols. Preference is given to trimethylolpropane triacrylate, trimethylolpropane trimethacrylate, pentaerythritol triallyl ether, pentaerythritol tetraallyl ether, pentaerythritol triacrylate and pentaerythritol tetraacrylate and also technical-grade mixtures thereof.

Useful other monomers C include various monoethylenically unsaturated monomers other than the A monomers, preference being given to monomers C such as vinyl acetate, vinyl propionate and vinylpyridine.

Particular preference is given to water-soluble monomers C, for example acrylonitrile, methacrylamide, acrylic acid, methacrylic acid, itaconic acid, maleic acid, maleic anhydride, N-vinylpyrrolidone, 2-hydroxyethyl acrylate, 2-hydroxyethyl methacrylate and acrylamido-2-methylpropanesulfonic acid. In addition to these, especially N-methylolacrylamide, N-methylolmethacrylamide, dimethylaminoethyl methacrylate and diethylaminoethyl methacrylate are suitable.

The glass transition temperature of the capsule wall can be (−60) to 180° C., preferably (−40) to 150° C.; the above glass transition temperature is that calculated according to Fox (see also Handbook of Polymer Science and Technology, 1989 or T. G. Fox, Bull. Am. Phys. Soc. (ser 11) 1, 123, 1956) from the weight fraction of the monomers and the glass transition temperature of the homopolymers, disregarding monomers having two or more than two copolymerizable, ethylenically unsaturated groups, i.e., the sum total of all other monomers is equal to 100% by weight.

Useful core material for the microcapsules includes liquid or solid water-insoluble to substantially water-insoluble materials, hereinafter referred to as lipophilic substances.

The lipophilic substance can be not only a single material but also a mixture, in the form of a solution, suspension or emulsion.

Lipophilic substances are selected for example from the group consisting of aliphatic and aromatic hydrocarbyl compounds, saturated or unsaturated C₆-C₃₀ fatty acids, fatty alcohols, C₆-C₃₀ fatty amines, fatty acid esters, natural and synthetic waxes, halogenated hydrocarbons, silicone oils, silicone resins, reactive and crosslinkable silicone oils, for example amino-functionalized silicone oils, low-flammability hydrophobic substances such as perfluorinated hydrocarbons and C₆-C₃₀ alcohols, fluorocarbon resins, aroma chemicals, scents, active ingredients, surfactants, biocides, dyes, color formers, pigments and crosslinkers.

The lipophilic substances can be additionally admixed with chemical or physical flame retardants. WO 2008/037600 describes impregnations of fluorocarbon resins with fire-inhibiting substances such as for example flame retardants based on silicates, borates, hydroxides and phosphates of the metals of main groups I to III, of zinc and of ammonium.

Examples which may be mentioned are:

aliphatic hydrocarbyl compounds such as saturated or unsaturated 010-040 hydrocarbons which are branched or preferably linear, for example such as n-tetradecane, n-pentadecane, n-hexadecane, n-heptadecane, n-octadecane, n-nonadecane, n-eicosane, n-heneicosane, n-docosane, n-tricosane, n-tetracosane, n-pentacosane, n-hexacosane, n-heptacosane, n-octacosane and also cyclic hydrocarbons, for example cyclohexane, cyclooctane, cyclodecane; aromatic hydrocarbyl compounds such as benzene, naphthalene, biphenyl, o-terphenyl, m-terphenyl, C₁-C₄₀-alkyl-substituted aromatic hydrocarbons such as dodecylbenzene, tetradecylbenzene, hexadecylbenzene, hexylnaphthalene or decylnaphthalene; saturated or unsaturated C₆-C₃₀ fatty acids such as lauric acid, stearic acid or behenic acid, preferably eutectic mixtures of decanoic acid with, for example, myristic acid, palmitic acid or lauric acid; fatty alcohols such as lauryl alcohol, stearyl alcohol, oleyl alcohol, myristyl alcohol, cetyl alcohol, mixtures such as coco fatty alcohol and also the so-called oxo process alcohols which are obtained by hydroformylation of a-olefins and further reactions; C₆-C₃₀ fatty amines, such as decylamine, dodecylamine, tetradecylamine or hexadecylamine; esters such as C₁-C₁₀-alkyl esters of fatty acids such as propyl palmitate, methyl stearate or methyl palmitate and also, preferably, their eutectic mixtures or methyl cinnamate; natural and synthetic waxes such as montan acid waxes, montan ester waxes, carnauba wax, polyethylene wax, oxidized waxes, polyvinyl ether wax, ethylene vinyl acetate wax or hard waxes from Fischer-Tropsch; halogenated hydrocarbons such as chloroparaffin, bromooctadecane, bromopentadecane, bromononadecane, bromoeicosane, bromodocosane; natural oils such as peanut oil, soyoil, silicone oils for example with molecular weights (Mw) of 100 to 150 000, densities of 0.94 to 0.97 and viscosities between 10 and 1 000 000 mPa·s; adhesives, aroma chemicals, scents and active ingredients such as crop protection agents, optionally as solution or suspension in the abovementioned lipophilic substances of groups a) to i); solutions or suspensions of dyes, color formers and organic and inorganic pigments in the abovementioned lipophilic substances of groups a) to i); crosslinkers, such as carbodiimides or other reactive, multifunctional compounds such as epoxides, amines, etc.

The microcapsules of the present invention are obtainable via a so-called in situ polymerization. The principle of microcapsule formation is based on the preparation of a stable oil-in-water emulsion from the monomers, a free-radical initiator, a protective colloid and the lipophilic substance to be encapsulated. Next the polymerization of the monomers is induced by heating and controlled as necessary by further raising the temperature, and the polymers produced form the capsule wall which encloses the lipophilic substance. This general principle is described for example in DE-A-10 2007 055 813, WO-A-2008/071649 and DE-A-101 39 171, the contents of all of which are expressly incorporated herein by reference.

The amount of microcapsule components used can be varied according to the material and the intended use. An amount of microcapsule component(s) in the range from 1% to 30% by weight and preferably in the range from 5% to 20% by weight, based on the weight of the melamine-formaldehyde precondensate, will be found advantageous.

Anionic, cationic and nonionic surfactants and also mixtures thereof can be used as dispersant/emulsifier.

Useful anionic surfactants include for example diphenylene oxide sulfonates, alkane- and alkylbenzenesulfonates, alkylnaphthalenesulfonates, olefinsulfonates, alkyl ether sulfonates, fatty alcohol sulfates, ether sulfates, α-sulfo fatty acid esters, acylaminoalkanesulfonates, acyl isethionates, alkyl ether carboxylates, N-acylsarcosinates, alkyl and alkylether phosphates. Useful nonionic surfactants include alkylphenol polyglycol ethers, fatty alcohol polyglycol ethers, fatty acid polyglycol ethers, fatty acid alkanolamides, ethylene oxide-propylene oxide block copolymers, amine oxides, glycerol fatty acid esters, sorbitan esters and alkylpolyglycosides. Useful cationic emulsifiers include for example alkyltriammonium salts, alkylbenzyldimethylammonium salts and alkylpyridinium salts.

The dispersants/emulsifiers can be added in amounts from 0.2% to 5% by weight, based on the melamine-formaldehyde precondensate.

The dispersants/emulsifiers and/or protective colloids can in principle be added to the crude dispersion at any time, but they can also already be present in the solvent at the time the microcapsule dispersion is introduced.

As curatives it is possible to use acidic compounds which catalyze the further condensation of the melamine resin. The amount of these curatives is generally in the range from 0.01% to 20% by weight and preferably in the range from 0.05% to 5% by weight, all based on the precondensate. Useful acidic compounds include organic and inorganic acids, for example selected from the group consisting of hydrochloric acid, sulfuric acid, phosphoric acid, nitric acid, formic acid, acetic acid, oxalic acid, toluenesulfonic acids, amidosulfonic acids, acid anhydrides and mixtures thereof.

Depending on the choice of melamine-formaldehyde precondensate, the mixture comprises a blowing agent. The amount of blowing agent in the mixture generally depends on the desired density for the foam.

In principle, the process of the present invention can use both physical and chemical blowing agents.

“Physical” or “chemical” blowing agents are suitable (Encyclopedia of Polymer Science and Technology, Vol. I, 3^{rd} ed., Additives, pages 203 to 218, 2003).

Useful “physical” blowing agents include for example hydrocarbons, such as pentane, hexane, halogenated, more particularly chlorinated and/or fluorinated, hydrocarbons, for example methylene chloride, chloroform, trichloroethane, hydrochlorofluorocarbons, partially halogenated hydrochlorofluorocarbons (H-CFCs), alcohols, for example methanol, ethanol, n-propanol, isopropanol, ethers, ketones and esters, for example methyl formate, ethyl formate, methyl acetate or ethyl acetate, in liquid form or air, nitrogen or carbon dioxide as gases.

Useful “chemical” blowing agents include for example isocyanates mixed with water, releasing carbon dioxide as active blowing agent. It is further possible to use carbonates and bicarbonates mixed with acids, in which case carbon dioxide is again produced. Also suitable are azo compounds, for example azodicarbonamide.

In a preferred embodiment of the invention, the mixture further comprises at least one blowing agent. This blowing agent is present in the mixture in an amount of 0.5% to 60% by weight, preferably 1% to 40% by weight and more preferably 1.5% to 30% by weight, based on the melamine-formaldehyde precondensate. It is preferable to add a physical blowing agent having a boiling point between 0 and 80° C.

In a further embodiment, in addition to the melamine-formaldehyde precondensate of the foam to be produced and the microcapsules, the mixture also comprises an emulsifier and also optionally a curative and optionally a blowing agent.

In a further embodiment, the mixture is free of further added substances. However, for some purposes it can be advantageous to add from 0.1% to 20% by weight, preferably from 0.1% to 10% by weight, based on the melamine-formaldehyde precondensate, of customary added substances, such as dyes, flame retardants, UV stabilizers, agents for reducing the toxicity of fire gases or for promoting carbonization.

It is also possible to add substances to the melamine-formaldehyde precondensate. In one embodiment, the abrasive foams comprise at least one added substance from the group consisting of dyes, scents, optical brighteners, UV absorbers and pigments. This added substance preferably forms a homogeneous distribution in the foam.

Useful pigments include the common inorganic natural pigments (chalk for example) or synthetic pigments (titanium oxides for example), but also organic pigments.

The release of the capsule core in the open-cell foam structure can be effected by thermal destruction (for example, hot air, various kinds of radiation, for example infrared or microwave radiation) or mechanical destruction (pressing, rolling, ultrasound, etc) of the capsule wall of the microcapsules.

In this way, the content of the capsules can be uniformly or almost uniformly released and the surface structure (struts and nodes) be wetted and rendered hydrophobic, for example, in the interior of the open-cell melamine resin foam structure also.

In the mechanical treatment, the melamine resin foam of the present invention can be pressed, which generally destroys the membrane residues and any hard but fragile struts and makes the foam more elastic, and this mechanical agitation may also result in the mechanical release taking place.

The pressing operation can be carried out as follows:

Pressing preferably takes place in each case as described in EP-A 0451535 by passing the foam through a defined gap between two counter-rotating rolls in a parallel arrangement.

In addition to passing the foam through a gap between two corotating rolls, it is also possible to transport the foam on a conveyor belt and have a roll pressing on the foam that rotates at a circumferential speed equal to the speed of movement of the foam. In addition, pressure can be exerted on the foam by placing the foam for example in a press in which a plunger presses on the foam. In this case, however, continuous pressing is not possible.

It is noted that capsule core release is not a requirement for all applications. For instance, fire-inhibiting substances only become active in the event of a fire, and can be effective even in encapsulated form.

In both embodiments, pressing preferably takes place in each case as described in EP-A 0451535 by passing the foam through a defined gap between two counter-rotating rolls in a parallel arrangement.

In addition to passing the foam through a gap between two corotating rolls, it is also possible to exert the pressure needed for impregnating by transporting the impregnated foam on a conveyor belt and having a roll pressing on the foam that rotates at a circumferential speed equal to the speed of movement of the foam. In addition, pressure can be exerted on the foam by placing the foam for example in a press in which a plunger presses on the foam. In this case, however, continuous pressing is not possible.

The density of the melamine resin foams produced according to the present invention is generally in the range from 3 to 100 g/l and more preferably in the range from 5 to 50 g/l.

The present invention melamine resin foams comprising microcapsules and also the melamine resin foams after destruction of the microcapsules are obtainable in a batch operation, preferably in a continuous operation as finite or continuous sheets, generally of any desired thickness, advantageously in layer thicknesses of 0.1 to 500 cm, preferably 0.5 to 200 cm, more preferably 1 to 100 cm, even more preferably 3 to 80 cm and yet even more preferably 5 to 50 cm. Shaped articles formed from melamine resin foams produced according to the present invention are obtainable in a continuous operation, preferably in a batch operation.

The melamine resin foams and also the hydrophobic melamine resin foams in the form of continuous sheets, finite sheets, shaped articles or some other configuration can be laminated in a generally customary manner on one, two, more or all sides with face layers, for example with paper, paperboard, glass vale, wood, gypsum board, metal sheets or metal foils, plastic or plastics film or sheet, which may each also be foamed, where appropriate. The face layers can be applied during the foaming operation or subsequently. In the case of subsequent application, it is advantageous to use an adhesion promoter.

The melamine resin foams of the present invention find application for acoustical and thermal (heat/cold) insulation in buildings, vehicle, railroad, ship and aircraft construction and in aeronautics, also as cushioning material in the covering of seat areas and as a specialized cleaning sponge for removing stubborn soiling.

### EXAMPLES

I. Microencapsulation

Aqueous phase

| | |
|---|---|
| 129.54 g | of water |
| 97.14 g | of 5% by weight aqueous solution of |
| | methylhydroxypropylcellulose (Culminal ® MHPC 100) |
| 24.28 g | of 10% by weight aqueous polyvinyl alcohol solution |
| | (Mowiol ® 15-79) |
| 1.05 g | of 2.5% by weight aqueous sodium nitrite solution |

Oily phase

| | | |
|---|---|---|
| 225 | g | of a silicone oil (Belsil DM5) |
| 21.25 | g | of methyl methacrylate |
| 3.75 | g | of butanediol diacrylate |
| 0.36 | g | of tert-butyl perpivalate |

Addition 1

2.75 g of 10% by weight aqueous solution of tert-butyl hydroperoxide

Feed Stream 1

20.15 g of 1.1% by weight aqueous solution of ascorbic acid

The above aqueous phase was introduced as initial charge at 40° C. The oily phase was added and the mixture was dispersed with a high-speed dissolver at 2500 rpm for 40 minutes. A stable emulsion was obtained. While stirring with an anchor stirrer, this emulsion was heated to 70° C. over 60 minutes and then to 85° C. over a further 60 minutes and maintained at 85° C. for one hour. Addition 1 was added and the microcapsule dispersion formed was cooled to 20° C. over 30 minutes with stirring while feed stream 1 was added to it by metered addition. Subsequently, the microcapsule dispersion was neutralized with 1.75 g of 25% by weight aqueous sodium hydroxide solution.

The microcapsule dispersion obtained had a solids content of 49% and an average particle size of D[4,3]=6.3 pm (Malvern, Fraunhofer diffraction).

II. Preparation of Inventive Modified Foams

II.1 Preparation of an Unmodified Foam

75 parts by weight of a spray-dried melamine-formaldehyde precondensate (molar ratio 1:3) were dissolved in 25 parts by weight of water. This resin solution was admixed with 3% by weight of formic acid, 2% by weight of a sodium Cu/Cu-alkyl sulfate, 20% by weight of pentane, all based on the resin. The mixture was subsequently stirred and then foamed up in a polypropylene mold by irradiation with microwave energy.

Foaming was followed by 30 minutes of drying.

II.2 Preparation of Inventive Modified Foams

Microcapsules with Wacker Belsil® DM5 75 parts by weight of a spray-dried melamine-formaldehyde precondensate (molar ratio 1:3) were dissolved in 25 parts by weight of water. This resin solution was admixed with 3% by weight of formic acid, 2% by weight of a sodium C₁₂/C₁₄-alkyl sulfate, 20% by weight of pentane and 15% by weight of an aqueous dispersion of microcapsules, all based on the resin. The microcapsules contain in the core a volatile silicone oil from

Wacker (Belsil® DM5). The solids content is 42% by weight, the silicone content is 37% by weight and the average particle size is 15 μm. The mixture was subsequently stirred and then foamed up in a polypropylene mold by irradiation with microwave energy. Foaming was followed by 30 minutes of drying.

III. Investigations Concerning Water Absorption

Unmodified melamine resin foam immediately absorbs water on contact therewith and sinks within seconds. By contrast, the foams modified with silicone oils float on water for several hours.

Furthermore, water droplets pipetted onto the surface of the foam do not penetrate into the modified foam, whereas an unmodified melamine resin foam is immediately wetted by the drop of water.

1.-5. (canceled)

6. A melamine-formaldehyde foam comprising microcapsules built into the structure of said foam.

7. The melamine resin foam according to claim 6, wherein the foam comprises from 0.01% to 50% by weight of microcapsules.

8. The melamine-formaldehyde foam according to claim 6, wherein the microcapsules are embedded in the foam structure.

9. The melamine-formaldehyde foam according to claim 6, wherein the microcapsules are embedded in the foam structure at the nodal points.

10. The melamine-formaldehyde foam according to claim 7, wherein the microcapsules are embedded in the foam structure at the nodal points.

11. A process for producing a melamine-formaldehyde foam comprising microcapsules built into the structure of said foam according to claim 6, which process comprises adding one or more components from the group consisting of melamine-formaldehyde precondensates or the individual components or the mixture of melamine and formaldehyde having said microcapsules and mixing this mixture with a blowing agent and optionally a solvent and optionally one or more dispersants/emulsifiers and/or additional components and being heated by means of hot air or microwave energy to a temperature above the boiling temperature of said blowing agent.

12. A cushioning which comprises utilizing the melamine-formaldehyde foam according to claim 6.

13. A process to provide heat or cold which comprises utilizing the melamine-formaldehyde foam according to claim 6.

14. A process for acoustical protection which comprises utilizing the melamine-formaldehyde foam according to claim 6.

15. A process for cleaning sponges which comprises utilizing the melamine-formaldehyde foam according to claim 6.

16. A melamine-formaldehyde foam comprising microcapsules built into the structure of said foam comprise an open-cell scaffolding of foamed material, the scaffolding comprising a multiplicity of interconnected, three-dimensionally branched struts, and in each of which the microcapsules are embedded into the foam structure.

17. The foam as claimed in claim 16, wherein the scaffolding comprising a multiplicity of interconnected, three-dimensionally branched struts, and in each of which the microcapsules are embedded into the foam structure at the nodal points.
